(19) United States
(12) Patent Application Publication
(10) Pub. No.: US 2018/0149955 A1
(43) Pub. Date: May 31, 2018

(54) ILLUMINATION DEVICE AND PROJECTOR

(71) Applicant: SEIKO EPSON CORPORATION, Tokyo (JP)

(72) Inventor: Koichi AKIYAMA, Matsumoto-Shi (JP)

(73) Assignee: SEIKO EPSON CORPORATION, Tokyo (JP)

(21) Appl. No.: 15/806,927

(22) Filed: Nov. 8, 2017

(30) Foreign Application Priority Data
Nov. 25, 2016 (JP) 2016-229147

(51) Int. Cl. G03B 21/20; G02B 27/48; G02B 27/14

(52) U.S. Cl. CPC G03B 21/204; G03B 21/2013; G02B 27/30; G02B 27/48; G02B 27/141; G03B 21/208

(57) ABSTRACT

An illumination device includes: a light source device that emits first light including laser light; a wavelength conversion element that includes a light-exiting surface and converts a portion of the first light into fluorescence; and a light diffusion element that is provided on the light-exiting surface. The wavelength conversion element is configured to emit second light including at least a portion of the laser light and the fluorescence from the light-exiting surface.

### BACKGROUND

### Technical Field

The present invention relates to an illumination device and a projector.

### Related Art

As an illumination device for a projector, an illumination device that converts a portion of blue light into yellow fluorescence with a phosphor layer while transmitting the remaining of the blue light to thereby generate white light has been known in the related art (e.g., see JP-A-2012-3923).

The fluorescence emitted from the phosphor layer has a large divergence angle because the fluorescence has a Lambertian light distribution; while the blue light has a divergence angle smaller than that of the fluorescence because the blue light is laser light. Therefore, color unevenness occurs, giving rise to the problem of failing to obtain uniform illumination light.

### SUMMARY

An advantage of some aspects of the invention is to provide an illumination device capable of reducing color unevenness. Moreover, another advantage of some aspects of the invention is to provide a projector including the illumination device.

A first aspect of the invention provides an illumination device including: a light source device that emits first light including, laser light; a wavelength conversion element that includes a light-exiting surface and converts a portion of the first light into fluorescence; and a light diffusion element that is provided on the light-exiting surface, wherein the wavelength conversion element is configured to emit second light including at least a portion of the laser light and the fluorescence from the light-exiting surface.

In the illumination device according to the first aspect, the second light emitted from the light-exiting surface is diffused by the light diffusion element. The laser light of the second light is diffused by the light diffusion element, so that the divergence angle of the laser light becomes large. On the other hand, the fluorescence of the second light previously has a Lambertian light distribution; therefore, the divergence angle of the fluorescence hardly changes even when the fluorescence is diffused by the diffusion element.

With this configuration, the difference between the divergence angle of the fluorescence and the divergence angle of the laser light is reduced. Therefore, the color unevenness of the second light is small.

In the first aspect, it is preferable that the light source device includes a laser element that emits red light and a light-emitting element that emits blue light, and that the wavelength conversion element includes a phosphor that converts a portion of the blue light into green light, and transmits a component of the blue light that is not converted into the green light and the red light.

The wavelength band of red laser light is narrower than the wavelength band of red fluorescence generated by a red phosphor. Since laser light having high color purity can be used as the red light, a color gamut is wide.

A second aspect of the invention provides a projector including: the illumination device according to the first aspect; a light modulator that modulates the second light in response to image information to form image light; and a projection optical system that projects the image light.

Since the projector according to the second aspect includes the light source device according to the first aspect, a high-quality color image with reduced color unevenness can be displayed.

In the second aspect, it is preferable that the illumination device further includes a collimating optical system, a lens integrator, and a condensing optical system, which are successively provided on an optical path of the second light.

According to this configuration, a high-quality image with reduced color unevenness and illuminance unevenness can be displayed.

In the second aspect, it is preferable that the illumination device further includes a condensing optical system provided on an optical path of the second light, that the light modulator is composed of a digital mirror device including a plurality of movable reflection elements, and that the condensing optical system is configured such that the light-exiting surface is optically conjugate with a surface including the plurality of movable reflection elements.

According to this configuration, a plurality of color lights having substantially the same divergence angle can be incident on the illumination region of the digital mirror device. Therefore, a color image with reduced color unevenness can be displayed.

### BRIEF DESCRIPTION OF THE DRAWINGS

The invention will be described with reference to the accompanying drawings, wherein like numbers reference like elements.

FIG. 1 shows a schematic configuration of an illumination device according to a first embodiment.

FIG. 2 shows a configuration of a main portion of a fluorescent light-emitting element.

FIG. 3 shows a schematic configuration of an illumination device according to a second embodiment.

FIG. 4 shows a configuration of a main portion of a fluorescent light-emitting element.

FIG. 5 shows a schematic configuration of a projector according to a third embodiment.

FIG. 6 shows a schematic configuration of a projector according to a fourth embodiment.

### DESCRIPTION OF EXEMPLARY EMBODIMENTS

Hereinafter, embodiments of the invention will be described in detail with reference to the drawings.

In the drawings used in the following description, a characteristic portion may be shown in an enlarged manner for clarity thereof, for convenience sake, and the dimension ratio and the like of components are not always the same as actual ones.

### First Embodiment

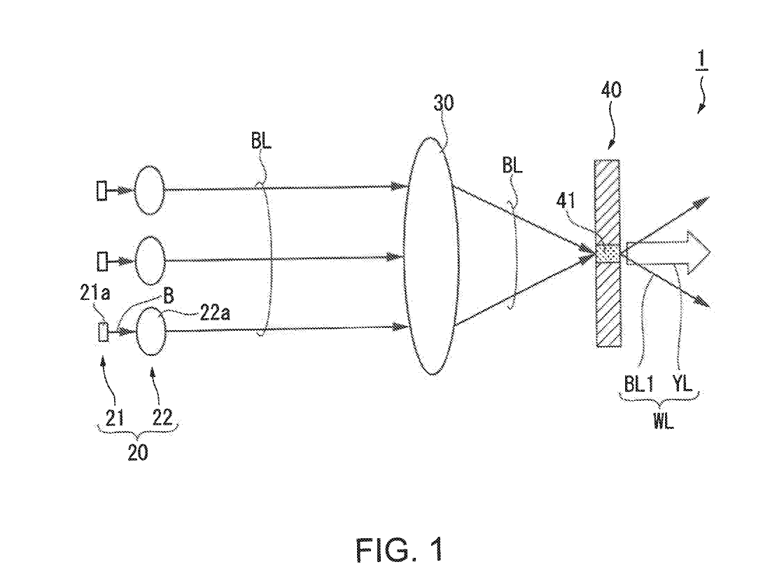

FIG. 1 shows a schematic configuration of an illumination device 1 according to a first embodiment.

As shown in FIG. 1, the illumination device 1 includes a light source device 20, a condensing lens 30, and a fluorescent light-emitting element 40.

The light source device 20 includes an array light source 21 and a collimator optical system 22. The array light source 21 includes a plurality of semiconductor lasers 21a as solid-state light sources. The plurality of semiconductor lasers 21a are disposed in an array in the plane orthogonal to an optical axis.

The semiconductor laser 21a emits a blue light ray B (e.g., laser light having a peak wavelength of 460 nm). The array light source 21 emits a bundle of light rays BL composed of a plurality of light rays B. In the embodiment, the light ray B corresponds to “laser light” in the appended claims, and the bundle of light rays BL corresponds to “first light” in the appended claims.

The bundle of light rays BL emitted from the array light source 21 is incident on the collimator optical system 22. The collimator optical system 22 converts the bundle of light rays BL emitted from the array light source 21 into parallel light flux.

The collimator optical system 22 includes, for example, a plurality of collimator lenses 22a disposed to be arranged in an array. The plurality of collimator lenses 22a are disposed respectively corresponding to the plurality of semiconductor lasers 21a.

The condensing lens 30 condenses the bundle of light rays BL emitted from the array light source 21 toward the fluorescent light-emitting element 40 as excitation light. In the embodiment, the condensing lens 30 is composed of one lens; however, the condensing lens 30 may be composed of a plurality of lenses.

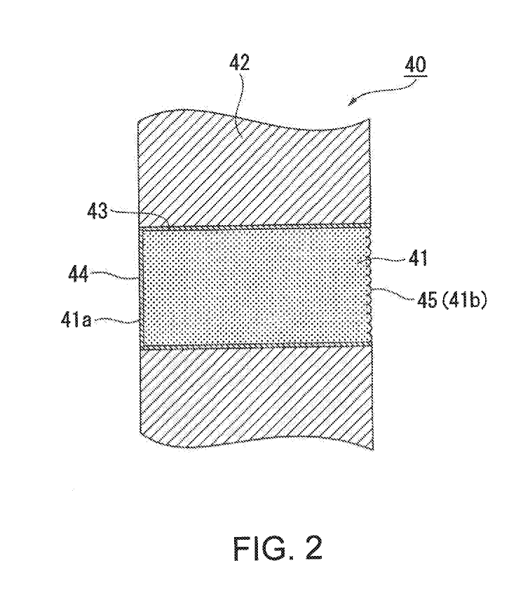

FIG. 2 shows a configuration of a main portion of the fluorescent light-emitting element 40.

As shown in FIG. 2, the fluorescent light-emitting element 40 includes a phosphor layer 41, a cooling member 42 supporting and cooling the phosphor layer 41, a reflection layer 43 provided between the cooling member 42 and the phosphor layer 41, a dichroic film 44 provided on a light-incident surface 41a of the phosphor layer 41, and a diffusion element 45 provided on a light-exiting surface 41b of the phosphor layer 41. In the embodiment, the phosphor layer 41 corresponds to a “wavelength conversion element” in the appended claims, and the diffusion element 45 corresponds to a “light diffusion element” in the appended claims.

The phosphor layer 41 contains phosphor particles (not shown) that absorb a portion of the excitation light (the bundle of light rays BL) and covert the portion into yellow fluorescence YL. As the phosphor particles, for example an yttrium aluminum garnet (YAG) based phosphor is used.

The forming material of the phosphor particles may be of one kind, or a mixture of particles formed using two or more kinds of materials may be used. For the phosphor layer 41, a phosphor layer having excellent heat resistance and surface processability is preferably used. As the phosphor layer 41, for example a phosphor layer obtained by dispersing phosphor particles in an inorganic binder such as alumina, or a phosphor layer obtained by sintering phosphor particles without using a binder is preferably used.

As the material of the cooling member 42, a material having high thermal conductivity and excellent heat dissipation property is preferably used. For example, examples of the material include metal such as aluminum or copper and ceramics such as aluminum nitride, alumina, sapphire, or diamond.

Specific examples of the reflection layer 43 include, for example, a metal reflection film having a high reflectance, such as of aluminum or silver. The reflection layer 43 reflects portions of the fluorescence YL and the bundle of light rays BL and thus directs the portions to the light-exiting surface 41b side of the phosphor layer 41.

The dichroic film 44 has the property of transmitting the bundle of light rays BL (blue light) and reflecting the fluorescence YL (yellow light). With this configuration, the fluorescence YL generated by the phosphor layer 41 and traveling toward the light-incident surface 41a side is reflected by the dichroic film 44 and thus efficiently directed to the light-exiting surface 41b side.

The diffusion element 45 is a concave-convex structure directly formed on the light-exiting surface 41b. In the embodiment, for example a smooth concave-convex structure such as a microlens array is formed as the diffusion element 45. By configuring the diffusion element 45 using the smooth concave-convex structure, an antireflection film (e.g., an AR coating film that transmits visible light) can be provided on the surface of the diffusion element 45.

Here, as a comparative example, the case in which a diffusion element is formed separately from the light-exiting surface 41b will be described. The size of a spot formed on the separate diffusion element by the fluorescence YL having a Lambertian light distribution is larger than the size of a spot formed on the diffusion element by blue light BL1 (laser light) having a small divergence angle.

That is, the size of a region (fluorescent light-emitting region) where the fluorescence YL is emitted from the diffusion element is different from the size of a region (blue light-emitting region) where the blue light BL1 is emitted from the diffusion element. In this case, there is a risk that a difference in use efficiency may occur between the blue light BL1 and the fluorescence YL in an optical system (e.g., a pickup optical system) disposed at the back of the phosphor layer 41.

In the embodiment, a component of the excitation light (the bundle of light rays BL) that is not converted into the fluorescence YL passes through the phosphor layer 41 and is emitted as the blue light BL1 from the light-exiting surface 41b. The blue light BL1 is combined with the yellow fluorescence YL emitted from the light-exiting surface 41b to generate white illumination light WL. In the embodiment, the illumination light WL corresponds to “second light” according to the appended claims.

In general, the fluorescence YL has a Lambertian light distribution and therefore has a large divergence angle. In contrast to this, since the blue light BL1 is laser light, the divergence angle thereof is smaller than that of the fluorescence YL when the phosphor layer 41 does not include the diffusion element 45.

In the embodiment, the blue light BL1 is diffused by the diffusion element 45 when emitted from the light-exiting surface 41b. With this configuration, the divergence angle of the blue light BL1 becomes large. On the other hand, since the fluorescence YL previously has a Lambertian light distribution, the divergence angle thereof hardly changes even when the fluorescence YL passes through the diffusion element 45.

According to the fluorescent light-emitting element 40 of the embodiment, the difference between the divergence angle of the fluorescence YL and the divergence angle of the blue light BL1 is small. Therefore, the color unevenness of the illumination light WL generated by combining the fluorescence YL and the blue light BL1, which have a small difference in divergence angle, is reduced.

Moreover, according to the embodiment, since the diffusion element 45 is directly formed on the light-exiting surface 41b as described above, the size of the spot of the fluorescence YL formed on the diffusion element 45 is the same as the size of the spot of the blue light BL1 formed on the diffusion element 45. That is, the size of the region where the fluorescence YL is emitted from the diffusion element 45 is the same as the size of the region where the blue light BL1 is emitted from the diffusion element 45.

Hence, the difference in use efficiency is less likely to occur between the blue light BL1 and the fluorescence YL in the optical system (e.g., a pickup optical system) disposed at the back of the phosphor layer 41. Therefore, the use efficiency of the illumination light WL can be increased.

### Second Embodiment

Subsequently, an illumination device of a second embodiment will be described. In the embodiment, configurations and members common to the first embodiment are denoted by the same reference numerals and signs, and a detailed description thereof is omitted.

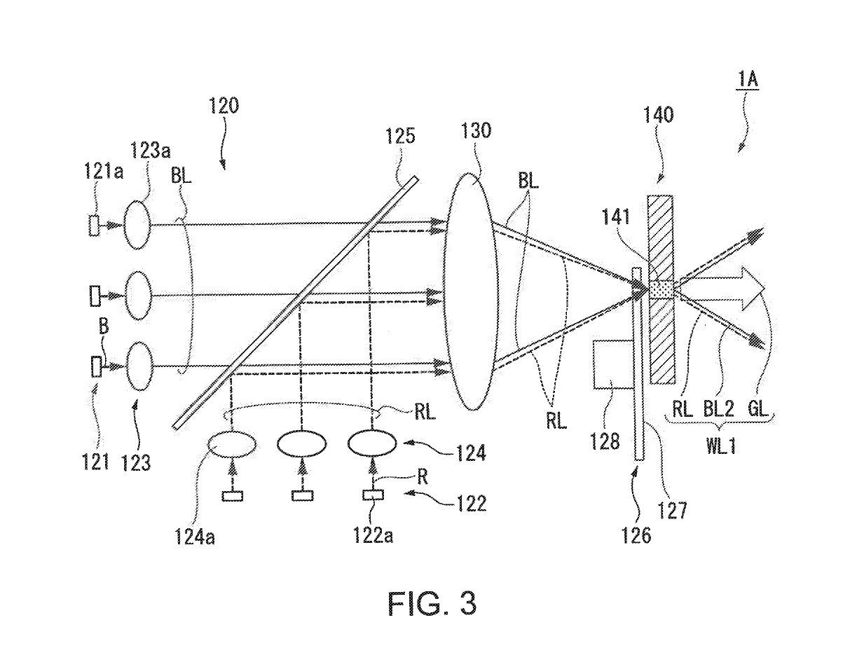

FIG. 3 shows a schematic configuration of the illumination device 1A according to the embodiment. As shown in FIG. 3, the illumination device 1A includes a light source device 120, a condensing lens 130, a fluorescent light-emitting element 140, and a rotating diffuser 126.

The light source device 120 includes a first array light source 121, a second array light source 122, a first collimator optical system 123, a second collimator optical system 124, and a dichroic mirror 125.

The first array light source 121 includes a plurality of semiconductor lasers 121a as solid-state light sources. The plurality of semiconductor lasers 121a are disposed in an array in the plane orthogonal to an optical axis. The semiconductor laser 121a emits the blue light ray B similarly to the first embodiment.

Based on the configuration described above, the first array light source 121 emits the bundle of light rays BL composed of the plurality of light rays B. In the embodiment, the semiconductor laser 121a corresponds to the “light-emitting element” in the appended claims, and the bundle of light rays BL corresponds to the “blue light” in the appended claims.

The bundle of light rays BL emitted from the first array light source 121 is incident on the first collimator optical system 123. The first collimator optical system 123 converts the bundle of light rays BL emitted from the first array light source 121 into parallel light flux. The first collimator optical system 123 includes, for example, a plurality of collimator lenses 123a disposed to be arranged in an array. The plurality of collimator lenses 123a are disposed respectively corresponding to the plurality of semiconductor lasers 121a.

The second array light source 122 includes a plurality of semiconductor lasers 122a as solid-state light sources. The plurality of semiconductor lasers 122a are disposed in an array in the plane orthogonal to an optical axis. The semiconductor laser 122a emits a red light ray R (e.g., laser light having a peak wavelength of 635 nm).

Based on the configuration described above, the second array light source 122 emits a bundle of light rays RL composed of a plurality of light rays R. In the embodiment, the semiconductor laser 122a corresponds to a “laser element” in the appended claims, and the bundle of light rays RL corresponds to “red light” in the appended claims.

The bundle of light rays RL emitted from the second array light source 122 is incident on the second collimator optical system 124. The second collimator optical system 124 converts the bundle of light rays RL emitted from the second array light source 122 into parallel light flux. The second collimator optical system 124 includes, for example, a plurality of collimator lenses 124a disposed to be arranged in an array. The plurality of collimator lenses 124a are disposed respectively corresponding to the plurality of semiconductor lasers 122a.

The dichroic mirror 125 has the property of transmitting the bundle of light rays BL emitted from the first array light source 121 and reflecting the bundle of light rays RL emitted from the second array light source 122.

The bundle of light rays BL transmitted through the dichroic mirror 125 and the bundle of light rays RL reflected by the dichroic mirror 125 are incident on the condensing lens 130. The condensing lens 130 condenses the bundles of light rays BL and RL to the fluorescent light-emitting element 140 and causes the bundles of light rays BL and RL to be incident thereon. In the embodiment, the condensing lens 130 is composed of one lens; however, the condensing lens 130 may be composed of a plurality of lenses.

In the embodiment, the rotating diffuser 126 is disposed between the condensing lens 130 and the fluorescent light-emitting element 140. Therefore, the bundles of light rays BL and RL are incident on the fluorescent light-emitting element 140 through the rotating diffuser 126.

The rotating diffuser 126 includes a diffuser 127 having a disk shape and a drive unit 128 that rotatably drives the diffuser 127. When the rotating diffuser 126 rotates the diffuser 127, the incident positions of the bundles of light rays BL and RL on the diffuser 127 change with time. Therefore, a pattern of speckles formed by the laser lights (the bundles of light rays BL and RL) emitted from the diffuser 127 also changes with time. The patterns of speckles are superimposed and averaged with time, so that the speckles are less likely to be recognized. Therefore, speckle noise can be suppressed more effectively.

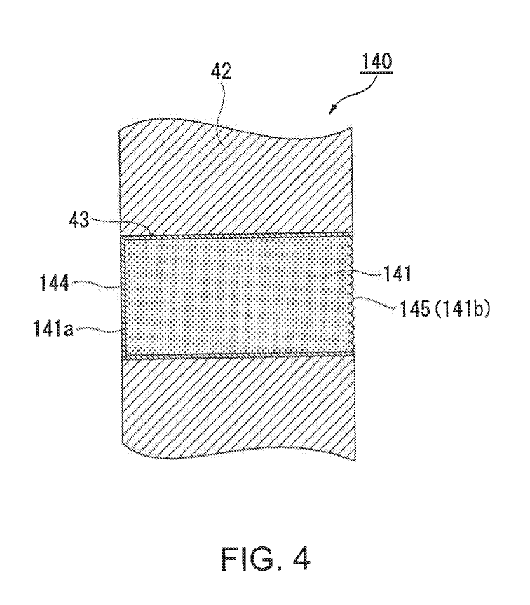

FIG. 4 shows a configuration of a main portion of the fluorescent light-emitting element 140.

As shown in FIG. 4, the fluorescent light-emitting element 140 includes a phosphor layer 141, the cooling member 42 supporting and cooling the phosphor layer 141, the reflection layer 43 provided between the cooling member 42 and the phosphor layer 141, a dichroic film 144 provided on a light-incident surface 141a of the phosphor layer 141, and a diffusion element 145 provided on a light-exiting surface 141b of the phosphor layer 141. In the embodiment, the phosphor layer 141 corresponds to the “wavelength conversion element” in the appended claims.

The phosphor layer 141 includes a phosphor (not shown) that absorbs a portion of the laser light emitted from the light source device 120, specifically, a portion of the bundle of light rays BL (blue light) and converts the portion into fluorescence GL as green light. As the green phosphor, for example a Lu₃Al₅O₁₂:Ce³⁺ based phosphor, a Y₃O₄:Eu²⁺ based phosphor, a (Ba,Sr)₂SiO₄:Eu²⁺ based phosphor, a Ba₃Si₆O₁₂N₂:Eu²⁺ based phosphor, a (Si,Al)₆(O,N)₈:Eu²⁺ based phosphor, or the like is used, The phosphor layer 141 transmits a component of the bundle of light rays BL (blue light) that is not converted into the fluorescence GL and the bundle of light rays RL (red light).

The dichroic film 144 has the property of transmitting the bundle of light rays BL (blue light) and the bundle of light rays RL (red light), which are emitted from the light source device 120, and reflecting the fluorescence GL (green light) generated by the phosphor layer 141. With this configuration, the fluorescence YL generated by the phosphor layer 141 and traveling toward the light-incident surface 141a side is reflected by the dichroic film 144 and thus efficiently directed to the light-exiting surface 141b side.

The diffusion element 145 is a concave-convex structure directly formed on the light-exiting surface 141b. The diffusion element 145 is formed of, for example, a smooth concave-convex structure such as a microlens array, and an antireflection film (e.g., an AR coating film that transmits visible light) is provided on the surface thereof.

According to the fluorescent light-emitting element 140 of the embodiment, the bundle of light rays RL, the fluorescence GL, and a portion of the bundle of light rays BL that is not converted into the fluorescence GL, in the laser light emitted from the light source device 120, are emitted from the light-exiting surface 141b. In the embodiment, a portion of the bundle of light rays BL passes through the phosphor layer 141 and is emitted as blue light BL2 from the light-exiting surface 141b.

In the embodiment, the bundle of light rays RL, the fluorescence GL, and the blue light BL2, which are emitted from the light-exiting surface 141b, are combined to generate white illumination light WL1. The blue light BL2 corresponds to a “component of the blue light that is not converted into the green light” according to the appended claims, and the illumination light WL1 corresponds to the “second light” according to the appended claims.

In the embodiment, the blue light BL2 and the bundle of light rays RL, each of which is composed of laser light, are diffused by the diffusion element 145 when emitted from the light-exiting surface 141b. With this configuration, the divergence angles of the blue light BL2 and the bundle of light rays RL become large. In contrast to this, since the fluorescence GL previously has a Lambertian light distribution, the divergence angle thereof hardly changes even when the fluorescence GL passes through the diffusion element 145.

With this configuration, the differences between the divergence angle of the fluorescence GL, the divergence angle of the bundle of light ray RL, and the divergence angle of the blue light BL2 are small. Therefore, the color unevenness of the illumination light WL1 generated by combining the fluorescence GL, the bundle of light rays RL, and the blue light BL2, which have small differences in divergence angle, is reduced.

Moreover, in the embodiment, laser light is used as the red light (the bundle of light rays RL) constituting the illumination light WL1. In general, the wavelength band of red laser light is narrower than the wavelength band of red fluorescence generated by a red phosphor. That is, in the embodiment, laser light having high color purity is used as the red light, and therefore, a color gamut is wider than that of the illumination device 1 of the first embodiment.

Moreover, according to the light source device 120 of the embodiment, even when the laser lights are used as the red light (the bundle of light rays RL) and the blue light BL2, which constitute the illumination light WL1, speckle noise can be effectively suppressed because the rotating diffuser 126 is included.

Also in the embodiment, since the diffusion element 145 is directly formed on the light-exiting surface 141b, the size of the spot of the fluorescence GL formed on the diffusion element 145, the size of the spot of the bundle of light rays RL formed on the diffusion element 45, and the size of the spot of the blue light BL2 formed on the diffusion element 45 are the same as each other. Therefore, similarly to the illumination device 1 of the first embodiment, differences in use efficiency are less likely to occur between the fluorescence GL, the bundle of light rays RL, and the blue light BL2 in an optical system (e.g., a pickup optical system) disposed at the back of the phosphor layer 41. Therefore, the use efficiency of the illumination light WL can be increased.

Although an example in which a semiconductor laser is used as a light-emitting element that emits light (the bundle of light rays BL) to excite the phosphor layer 141 has been mentioned in the embodiment, a blue light-emitting diode may be used instead of the semiconductor laser.

Moreover, the rotating diffuser 126 used for reducing speckles in the embodiment may be applied to the illumination device 1 of the first embodiment. By doing this, speckles due to blue laser light can be reduced similarly.

Although an example in which the bundle of light rays BL emitted from the first array light source 121 and the bundle of light rays RL emitted from the second array light source 122 are combined by the dichroic mirror 125 has been mentioned in the embodiment, the invention is not limited to this example. For example, the first array light source 121 and the second array light source 122 may be disposed on the same plane, and the two bundles of light rays BL and RL may be emitted in the same direction. This eliminates the need for the dichroic mirror 125 from the configuration of the light source device 120, and therefore, a device configuration is simplified.

### Third Embodiment

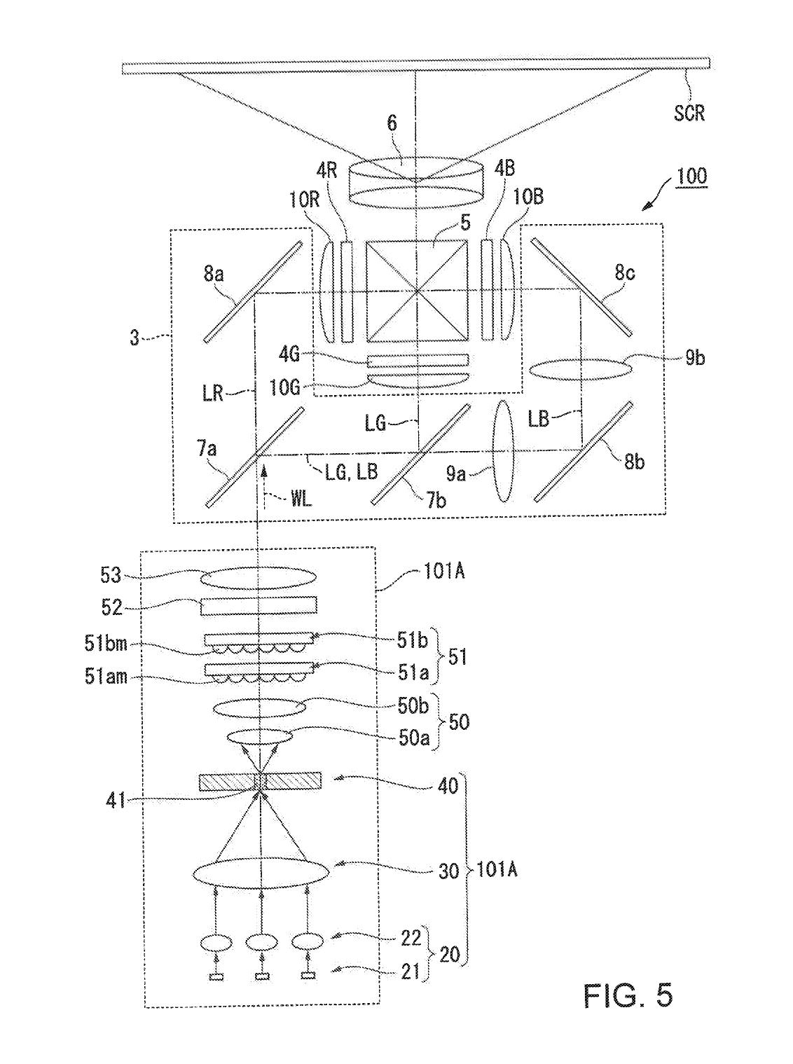

Subsequently, a projector according to a third embodiment of the invention will be described. FIG. 5 shows a schematic configuration of the projector 100 according to the embodiment.

As shown in FIG. 5, the projector 100 of the embodiment is a projection-type image display device that projects a color image (image light) onto a screen (projected surface) SCR.

The projector 100 uses three light modulators corresponding to the respective color lights of red light LR, green light LG, and blue light LB. The projector 100 uses a semiconductor laser, from which high luminance, high output is obtained, as a light source of an illumination device.

As shown in FIG. 5, the projector 100 roughly includes an illumination device 101, a color separation optical system 3, a light modulator 4R, a light modulator 4G, a light modulator 4B, a combining optical system 5, and a projection optical system 6.

The illumination device 101 includes an illumination light-generating unit 101A, a collimating optical system 50, a lens integrator 51, a polarization conversion element 52, and a superimposing optical system 53. In the embodiment, the illumination light-generating unit 101A includes the components (the light source device 20, the condensing lens 30, and the fluorescent light-emitting element 40) of the illumination device 1 of the first embodiment.

With this configuration, the illumination light-generating unit 101A emits the illumination light WL with less color unevenness toward the collimating optical system 50. The collimating optical system 50 is composed of, for example, two lenses 50a and 50b. The collimating optical system 50 collimates the illumination light WL.

The illumination light WL collimated by the collimating optical system 50 is incident on the lens integrator 51. The lens integrator 51 is composed of, for example, a first lens array 51a and a second lens array 51b.

The first lens array 51a includes a plurality of first small lenses 51am. The plurality of first small lenses 51am are arranged in a matrix of multiple rows and multiple columns in the plane orthogonal to an illumination optical axis. The first lens array 51a divides the illumination light WL into a plurality of partial luminous fluxes.

The shape of each of the first small lenses 51am is substantially similar to the shape of the image forming region of each of the light modulators 4R, 4G, and 4B. With this configuration, the partial luminous fluxes emitted from the first lens array 51a can be efficiently incident on the image forming regions of each of the light modulators 4R, 4G, and 4B. Therefore, high light-use efficiency can be realized.

The second lens array 51b includes a plurality of second small lenses 51bm. The shape of each of the plurality of second small lenses 51bm is the same as the shape of each of the plurality of first small lenses 51am. The second small lenses 51bm are in one-to-one correspondence with the first small lenses 51am. The plurality of second small lenses 51bm are arranged in a matrix of multiple rows and multiple columns in the plane orthogonal to the illumination optical axis.

The polarization conversion element 52 converts the illumination light WL into linearly polarized light. The polarization conversion element 52 is composed of, for example, a polarization separation film, a retardation film, and a mirror. In the embodiment, the polarization conversion element 52 is not an indispensable configuration and may be omitted.

The superimposing optical system 53 provided at the back of the polarization conversion element 52 superimposes, in cooperation with a field lens 10R, a field lens 10G, and a field lens 10B to be described later, the plurality of partial luminous fluxes emitted from the second lens array 51b on each other on the image forming regions of the light modulators 4R, 4G, and 4B as illuminated regions. With this configuration, the intensity distribution of light that illuminates the light modulators 4R, 4G, and 4B is made uniform.

The color separation optical system 3 separates the illumination light WL into the red light LR, the green light LG, and the blue light LB. The color separation optical system 3 roughly includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a has the function of separating the illumination light WL from the light source device 20 into the red light LR and the other light (the green light LG and the blue light LB). The first dichroic mirror 7a transmits the separated red light LR while reflecting the other light (the green light LG and the blue light LB). On the other hand, the second dichroic mirror 7b has the function of separating the other light into the green light LG and the blue light LB. The second dichroic mirror 7b reflects the separated green light LG while transmitting the blue light LB.

The first total reflection mirror 8a is disposed on the optical path of the red light LR and reflects the red light LR transmitted through the first dichroic mirror 7a toward the light modulator 4R. On the other hand, the second total reflection mirror 8b and the third total reflection mirror 8c are disposed on the optical path of the blue light LB and reflect the blue light LB transmitted through the second dichroic mirror 7b toward the light modulator 4B. It is not necessary to dispose a total reflection mirror on the optical path of the green light LG. The green light LG is reflected by the second dichroic mirror 7b toward the light modulator 4G.

The first relay lens 9a and the second relay lens 9b are disposed on the light-exiting side of the second dichroic mirror 7b on the optical path of the blue light LB. The first relay lens 9a and the second relay lens 9b have the function of compensating for the light loss of the blue light LB due to the fact that the optical path length of the blue light LB is longer than the optical path length of the red light LR or the green light LG.

While transmitting the red light LR, the light modulator 4R modulates the red light LR in response to image information to form image light corresponding to the red light LR. While transmitting the green light LG, the light modulator 4G modulates the green light LG in response to image information to form image light corresponding to the green light LG. While transmitting the blue light LB, the light modulator 4B modulates the blue light LB in response to image information to form image light corresponding to the blue light LB.

For example, a transmissive liquid crystal panel is used for each of the light modulator 4R, the light modulator 4G, and the light modulator 4B. A pair of polarizers (not shown) are disposed on the incident side and the exiting side of the liquid crystal panel and configured to transmit only linearly polarized light in a specific direction.

The field lens 10R, the field lens 10G, and the field lens 10B are respectively disposed on the incident sides of the light modulator 4R, the light modulator 4G, and the light modulator 4B. The field lens 10R, the field lens 10G, and the field lens 10B collimate the red light LR, the green light LG, and the blue light LB to be respectively incident on the light modulator 4R, the light modulator 4G, and the light modulator 4B.

The image lights from the light modulator 4R, the light modulator 4G, and the light modulator 4B are incident on the combining optical system 5, so that the combining optical system 5 combines the image lights corresponding to the red light LR, the green light LG, and the blue light LB and emits the combined image light toward the projection optical system 6. For example, a cross dichroic prism is used for the combining optical system 5.

The projection optical system 6 is composed of a projection lens group. The projection optical system 6 enlarges and projects the image light combined by the combining optical system 5 onto the screen SCR. With this configuration, an enlarged color video (image) is displayed on the screen SCR.

According to the projector 100 of the embodiment as described above, since the illuminated regions of the light modulators 4R, 4G, and 4B are irradiated with the illumination light WL having a uniform illuminance distribution, a high-quality image with reduced color unevenness and illuminance unevenness can be displayed.

Although an example in which the illumination device 101 uses the components of the illumination device 1 of the first embodiment as the illumination light-generating unit 101A has been mentioned in the embodiment, the invention is not limited to this example.

For example, the illumination device 101 may be replaced with an illumination device 101 that uses the components (the light source device 120, the condensing lens 130, and the fluorescent light-emitting element 140) of the illumination device 1A of the second embodiment as the illumination light-generating unit 101A. By doing this, it is possible to display a color image having a widened color gamut while making speckles less likely to be visually recognized.

### Fourth Embodiment

Subsequently, a projector according to a fourth embodiment of the invention will be described. The projector of the embodiment differs from the projector 100 of the third embodiment in that a micromirror-type light modulator is used.

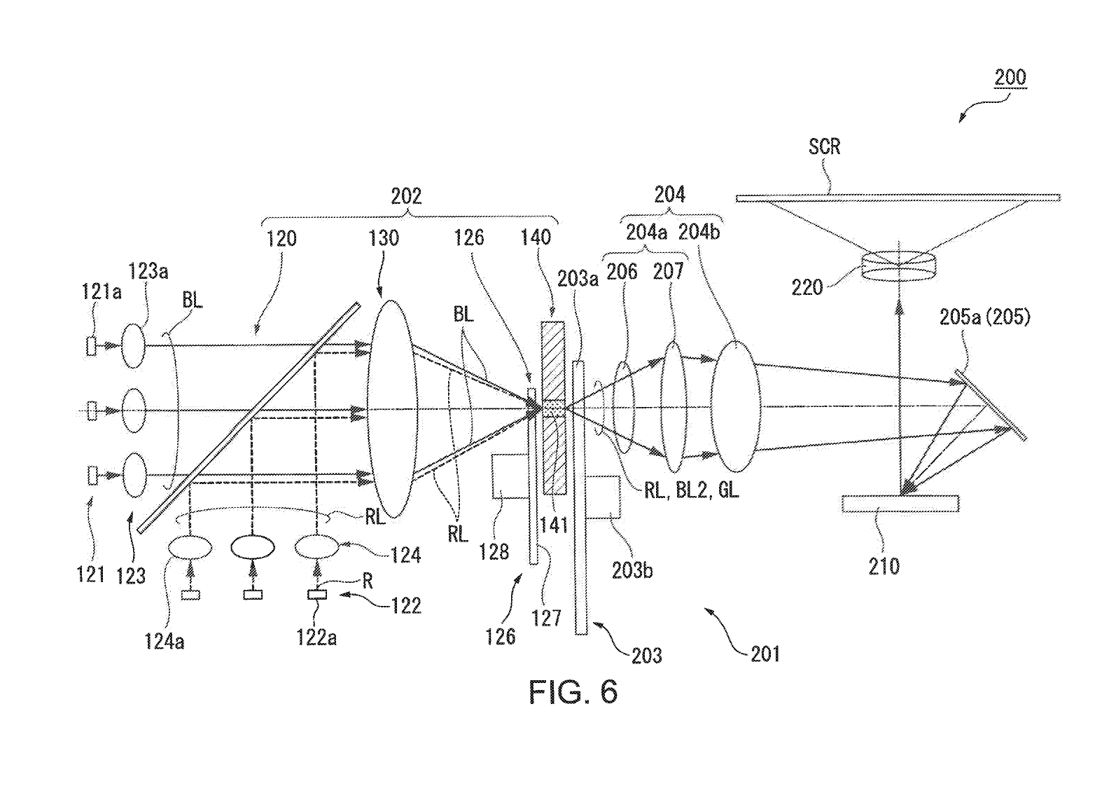

FIG. 6 shows a schematic configuration of the projector 200 according to the embodiment.

As shown in FIG. 6, the projector 200 of the embodiment includes an illumination device 201, a micromirror-type light modulator 210, and a projection optical system 220.

The illumination device 201 includes an illumination light-generating unit 202, a color wheel 203, a condensing optical system 204, and a light guide optical system 205. In the embodiment, the illumination light-generating unit 202 includes the components (the light source device 120, the condensing lens 130, the fluorescent light-emitting element 140, and the rotating diffuser 126) of the illumination device 1A of the second embodiment.

Light emitted from the illumination light-generating unit 202 is incident on the color wheel 203.

The color wheel 203 includes, for example, a wheel member 203a and a drive unit 203b that rotates the wheel member 203a. The wheel member 203a includes a transmitting portion (opening) that transmits the red light (the bundle of light rays RL), a first color filter portion that transmits only the blue light BL2, and a second color filter portion that transmits only the green light (the fluorescence GL).

The illumination device 201 changes the light to be emitted from the illumination light-generating unit 202 in synchronization with the rotation of the color wheel 203. Specifically, the illumination device 201 selectively drives the second array light source 122 of the light source device 120 so as to emit only the red light (the bundle of light rays RL) from the illumination light-generating unit 202 in synchronization with the timing at which the transmitting portion of the color wheel 203 reaches the incident position of the light from the illumination light-generating unit 202.

Moreover, the illumination device 201 selectively drives the first array light source 121 of the light source device 120 so as to emit the green light (the fluorescence GL) and the blue light BL2 from the illumination light-generating unit 202 in synchronization with the timing at which the first color filter portion or the second color filter portion of the color wheel 203 reaches the light incident position.

Based on the configuration described above, the color wheel 203 successively transmits the red light (the bundle of light rays RL), the green light (the fluorescence GL), and the blue light BL2 and directs them to the condensing optical system 204.

The condensing optical system 204 includes a collimating optical system 204a and a condensing lens 204b. The collimating optical system 204a is composed of, for example, two lenses 206 and 207. The collimating optical system 204a collimates the light emitted from the illumination light generating unit 202. The condensing lens 204b condenses the light emitted from the illumination light-generating unit 202 onto the micromirror-type light modulator 210.

The light guide optical system 205 disposed at the back of the condensing optical system 204 is composed of a reflection mirror 205a and causes the red light (the bundle of light rays RL), the green light (the fluorescence GL), and the blue light BL2 to be successively incident on the micromirror-type light modulator 210.

For example, a digital micromirror device (DMD) is used as the micromirror-type light modulator 210. The DMD includes a plurality of micromirrors (movable reflection elements) arranged in a matrix. The DMD changes the tilt directions of the plurality of micromirrors and thus switches the reflection direction of incident light between a direction in which the light is incident on the projection optical system 220 and a direction in which the light is not incident on the projection optical system 220.

As described above, the DMD successively modulates the red light (the bundle of light rays RL), the green light (the fluorescence GL), and the blue light BL2 emitted from the illumination device 201 to generate a green image, a red image, and a blue image. The projection optical system 220 projects the green image, the red image, and the blue image onto a screen (not shown).

In the embodiment, the condensing optical system 204 is configured such that the light-exiting surface in the illumination light-generating unit 202, that is, the light-exiting surface 141b of the fluorescent light-emitting element 140 (the phosphor layer 141) is optically conjugate with the surface including the plurality of micromirrors.

With this configuration, the lights (the bundle of light rays RL, the fluorescence GL, and the blue light BL2) having a divergence angle substantially the same as each other can be incident on the illumination region of the micromirror-type light modulator 210. Therefore, a color image with reduced color unevenness can be displayed.

Moreover, unlike a related-art projector using a micromirror-type light modulator, the projector 200 of the embodiment does not require a rod for homogenizing the light emitted from the illumination device 201. Therefore, the projector 200 can be downsized.

The invention is not limited to the details of the embodiments but can be appropriately changed in the scope not departing from the spirit of the invention.

Although the projector 100 including the three light modulators 4R, 4G, and 4B has been illustrated in the third embodiment, the invention can be applied also to a projector that displays a color video with one light modulator.

Although an example in which the light source device according to the invention is mounted in the projector has been shown in the embodiments, the invention is not limited to this example. The light source device according to the invention can be applied also to a luminaire, a headlight of an automobile, and the like.

The entire disclosure of Japanese Patent Application No. 2016-229147, filed on Nov. 25, 2016 is expressly incorporated by reference herein.

What is claimed is:

1. An illumination device comprising:
a light source device that emits first light including laser light;
a wavelength conversion element that includes a light-exiting surface and converts a portion of the first light into fluorescence; and
a light diffusion element that is provided on the lightt-exiting surface, wherein
the wavelength conversion element is configured to emit second light including at least a portion of the laser light and the fluorescence from the light-exiting surface.

2. The illumination device according to claim 1, wherein
the light source device includes a laser element that emits red light and a light-emitting element that emits blue light, and
the wavelength conversion element includes a phosphor that converts a portion of the blue light into green light, and transmits a component of the blue light that is not converted into the green light and the red light.

3. A projector comprising:
the illumination device according to claim 1;
a light modulator that modulates the second light in response to image information to form image light; and
a projection optical system that projects the image light.

4. A projector comprising:
the illumination device according to claim 2;
a light modulator that modulates the second light in response to image information to form image light; and
a projection optical system that projects the image light.

5. The projector according to claim 3, wherein
the illumination device further includes a collimating optical system, a lens integrator, and a condensing optical system, which are successively provided on an optical path of the second light.

6. The projector according to claim 4, wherein
the illumination device further includes a collimating optical system, a lens integrator, and a condensing optical system, which are successively provided on an optical path of the second light.

7. The projector according to claim 3, wherein
the illumination device further includes a condensing optical system provided on an optical path of the second light,
the light modulator is composed of a digital mirror device including a plurality of movable reflection elements, and
the condensing optical system is configured such that the light-exiting surface is optically conjugate with a surface including the plurality of movable reflection elements.

8. The projector according to claim 4, wherein
the illumination device further includes a condensing optical system provided on an optical path of the second light,
the light modulator is composed of a digital mirror device including a plurality of movable reflection elements, and
the condensing optical system is configured such that the light-exiting surface is optically conjugate with a surface including the plurality of movable reflection elements.
